(19) United States
(12) Patent Application Publication
(10) Pub. No.: US 2026/0333158 A1
(43) Pub. Date: Oct. 22, 2026

(54) ADAPTIVE MEASUREMENTS FOR L1/L2 MOBILITY

(71) Applicant: InterDigital Patent Holdings, Inc., Wilmington, DE (US)

(72) Inventors: Martino M. Freda, Laval (CA); Brian Martin, Farnham (GB); Oumer Teyeb, Montreal (CA); Paul Marinier, Brossard (CA)

(73) Assignee: InterDigital Patent Holdings, Inc., Wilmington, DE (US)

(21) Appl. No.: 19/112,394

(22) PCT Filed: Sep. 27, 2023
(86) PCT No.: PCT/US2023/033816

§ 371 Date: Mar. 17, 2025

Related U.S. Application Data
(60) Provisional application No. 63/410,960, filed on Sep. 28, 2022.
(60) Provisional application No. 63/421,745, filed on Nov. 2, 2022.

(51) Int. Cl. H04W 36/00; H04W 36/08

(52) U.S. Cl. CPC H04W 36/0085; H04W 36/00725; H04W 36/08

(57) ABSTRACT

A device, such as a wireless transmit/receive unit, may receive a first candidate cell information and/or a second candidate cell information. The first candidate cell information may indicate a first candidate cell and/or a first synchronization configuration and the second candidate cell information may indicate a second candidate cell and/or a second synchronization configuration. The WTRU may receive a first measurement configuration and/or a second measurement configuration. The WTRU may select a measurement configuration associated with the first candidate cell based on whether the first synchronization configuration indicates that the first candidate cell is associated with a random access channel (RACH) procedure or a RACH-less procedure. The WTRU may perform a measurement of the first candidate cell based on the selected measurement configuration. The WTRU may transmit a measurement report indicating the measurement of the first candidate cell.

### CROSS-REFERENCE TO RELATED APPLICATIONS

This application claims the benefit of U.S. Provisional Application Ser. No. 63/410,960 filed Sep. 28, 2022 and U.S. Provisional Application Ser. No. 63/421,745 filed Nov. 2, 2022, the contents of which are incorporated by reference herein.

### BACKGROUND

In wireless communication systems, such as new radio (NR) systems, a device, such as a wireless transmit/receive unit (WTRU), may undergo a handoff procedure from a source cell to a target cell. Layer 3 (L3) measurements may be used to determine viability of handoff to the target cell. Layer 1 (L1) measurements and/or layer 2 (L2) measurements may be used to determine handoff viability but may suffer adverse effects compared to L3 measurements. Systems, methods, and/or instrumentalities for reducing mobility using L1/L2 measurements without such adverse effects are described herein.

### SUMMARY

Systems, methods, and instrumentalities are described herein for selecting a measurement configuration for a candidate cell. A device, such as a wireless transmit/receive unit (WTRU), may select a measurement configuration for a candidate cell. For example, a WTRU may select measurement configuration for a candidate L1 cell and/or L2 candidate cell based on uplink (UL) synchronization status to the cell.

In examples, a WTRU may receive candidate cell information. For example, the WTRU may receive a first candidate cell information and a second candidate cell information. The candidate cell information may indicate a candidate cell and/or a synchronization configuration. In examples, the first candidate cell information may indicate a first candidate cell and/or a first synchronization configuration. In examples, the second candidate cell information may indicate a second candidate cell and/or a second synchronization configuration.

In examples, a WTRU may receive measurement configuration. For example, the WTRU may receive a first measurement configuration and a second measurement configuration. The WTRU may select a measurement configuration based on one or more of a synchronization configuration, such as an UL synchronization configuration, a type of resource available for transmission, the last time that timing information (e.g., timing advance) associated with a candidate cell has been received, or duration that UL data buffered at the WTRU. The measurement configuration may be or may include one or more of filtering coefficients or time to trigger (TTT).

In examples, a WTRU may select the measurement configuration associated with the first candidate cell and/or the second candidate cell. For example, a WTRU may select the measurement configuration associated with the first candidate cell based on whether the first synchronization configuration indicates that the first candidate cell is associated with a random access channel (RACH) procedure or a RACH-less procedure. If the first candidate cell is associated with the RACH procedure, the WTRU may select the first measurement configuration. The determination that the first candidate cell is associated with the RACH procedure may be based on the first synchronization configuration indicating that the first candidate cell is unsynchronized. If the first candidate cell is associated with the RACH-less procedure, the WTRU may select the second measurement configuration. The determination that the first candidate cell is associated with the RACH-less procedure may be based on the first synchronization configuration indicating that the first candidate cell is synchronized.

In examples, a WTRU may select the measurement configuration based on a type of resource available for transmission. For example, the WTRU may determine whether a resource available for transmission is associated with a medium access control (MAC) reset. Based on a determination that the resource available for transmission is associated with the MAC reset, the WTRU may select the first measurement configuration. Based on a determination that the resource available for transmission is not associated with the MAC reset, the WTRU may select the second measurement configuration. The resource available for transmission that is associated with a MAC reset may be associated with an ultra-reliable low latency (URLLC)-type traffic. The resource available for transmission that is not associated with a MAC reset may be associated with an enhanced massive mobile broadband (eMBB)-type traffic.

In examples, a WTRU may select the measurement configuration based on the last time that timing information (e.g., timing advance) associated with a candidate cell has been received. Based on the first synchronization configuration, the WTRU may determine the time that timing information associated with the first candidate cell has been received. For example, the WTRU may determine the time elapsed since the timing information associated with the first candidate cell has been received. Based on the second synchronization configuration, the WTRU may determine the time that timing information (e.g., timing advance) associated with the second candidate cell has been received. For example, the WTRU may determine the time elapsed since the timing information associated with the second candidate cell has been received. The WTRU may determine whether the time elapsed since that the timing information has been received is above a threshold level or below the threshold level. If the WTRU determines that the time elapsed since the timing information has been received is above a threshold level, the WTRU may select the first measurement configuration. If the WTRU determines that the last time that the timing information has been received is below the threshold level, the WTRU may select the second measurement configuration.

In examples, a WTRU may select the measurement configuration based on an amount of UL data buffered at the WTRU. For example, the WTRU may determine whether an amount of uplink (UL) data buffered and/or an amount of time since the UL data has been buffered at the WTRU exceeds a threshold level. If the WTRU determines that the amount of UL data buffered at the WTRU exceeds the threshold level, the WTRU may select the first measurement configuration. If the WTRU determines that the amount of UL data buffered at the WTRU is below (e.g., does not exceed) the threshold level, the WTRU may select the second measurement configuration. In examples, the WTRU may determine the amount of time UL data has been buffered exceeds a threshold level. If the WTRU may determines that the amount of time UL data has been buffered exceeds a threshold level, the WTRU may select the first measurement configuration. If the WTRU may determines that the amount of time UL data has been buffered is below a threshold level, the WTRU may select the second measurement configuration.

Based on the one or more of synchronization configurations, such as an UL synchronization configuration, a type of resource available for transmission, the last time that timing information associated with a candidate cell has been received, and/or an amount of UL data/amount of time since the UL data has been buffered at the WTRU described herein, the WTRU may perform a measurement of the first candidate cell based on the selected measurement configuration. The WTRU may transmit a measurement report. The measurement report may indicate the measurement of the first candidate cell.

In examples, the WTRU may select a measurement configuration associated with the second candidate cell. As described herein, based on the one or more of synchronization configurations, such as an UL synchronization configuration, a type of resource available for transmission, the last time that timing information associated with a candidate cell has been received, and/or an amount of UL data buffered at the WTRU, the WTRU may perform a measurement (e.g., a second measurement) of the second candidate cell based on the selected measurement configuration. The WTRU may transmit a measurement report, such as a second measurement report. For example, the second measurement report may indicate the measurement of the second candidate cell.

In communications systems, such as communication networks, an example WTRU may apply one or more measurement parameters (filtering coefficients, time to trigger (TTT), and/or the like) for measuring Layer 1 (L1) quality of a cell based on downlink (DL) / UL synchronization status to the cell. Such WTRU may receive one or more of a first set of measurement parameters (e.g., filtering coefficients, TTT, and/or the like) associated with cells to which the WTRU is neither UL or DL synchronized; a second set of measurement parameters associated with cells to which the WTRU is DL synchronized but not UL synchronized; or a third set of measurement parameters to be applied to cells to which the WTRU is both UL and DL synchronized.

In examples, based on one or more of the sets of measurement parameters, a WTRU may determine, for a specific neighbor cell which is an L1/Layer 2 (L2) mobility target, whether to maintain DL synchronization to the cell based on the Layer 3 (L3) reference signal received power (RSRP) of the cell and a number of supported synchronization cells.

In examples, based on one or more of the sets of measurement parameters, a WTRU may determine whether the WTRU is UL synchronized to the cell based on whether the cell has the same UL timing as the serving cell. Based on whether the cell is DL/UL synchronized, the WTRU may apply the associated measurement parameters if measuring the cell. If measurement of the cell triggers generation of a measurement report, any such WTRU may transmit the measurement report to the network.

In examples, an example WTRU may apply one or more measurement parameters based on an indication of priority of data available for transmission in buffers associated with the WTRU. Such WTRU may receive a first set of measurement parameters to be applied to neighbor cells if high priority data is available for transmission and/or a second set of measurement parameters to be applied to neighbor cells if high priority data is unavailable for transmission. Such WTRU may receive a priority threshold indicating whether data is high priority or not. If high priority data is available in buffers associated with the WTRU, the WTRU may apply the first set of measurement parameters for measuring L1/L2 candidates. If no high priority data is available in buffers associated with the WTRU, the WTRU may apply the second set of measurement parameters for measuring L1/L2 candidates. If the measurement of the cell triggers generation of a measurement report, the WTRU may transmit the measurement report to the network.

A WTRU may be configured with different measurement parameters to use on different cells and may select a measurement parameter to use based on one or more of the following: whether a cell being measured is an SCell; a message from the network (e.g., a MAC control element (CE) or downlink control information (DCI)); whether a target cell is configured with a reset of a protocol layer (e.g., MAC/radio link control (RLC) reset); whether a target cell is associated with RACH-based or RACH-less procedure; or based on the results of a measurement (e.g., a different measurement, such as a different measurement type, measurement of a different cell or set of cells, and/or the like). In examples, using different measurement parameters (e.g., filter coefficients) on different cells may be or may include, for a given cell, using one or more parameters that are specific to the given cell.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a message flow diagram illustrating an example handover procedure in new radio (NR).

FIG. 3 is a procedure diagram illustrating an example L1/2 inter-cell mobility operation.

FIG. 4 illustrates an example flow diagram of a WTRU selecting a measurement configuration for a cell and performing a measurement on the cell based on the selected measurement configuration.

### DETAILED DESCRIPTION

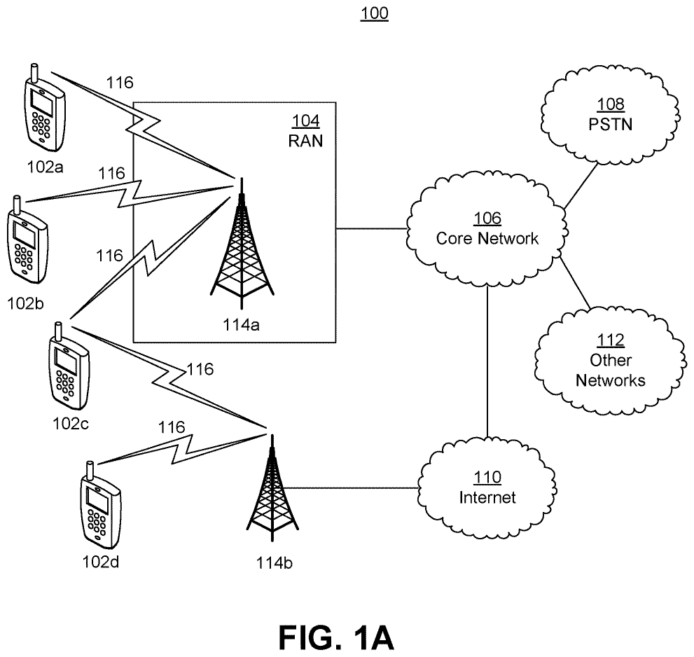

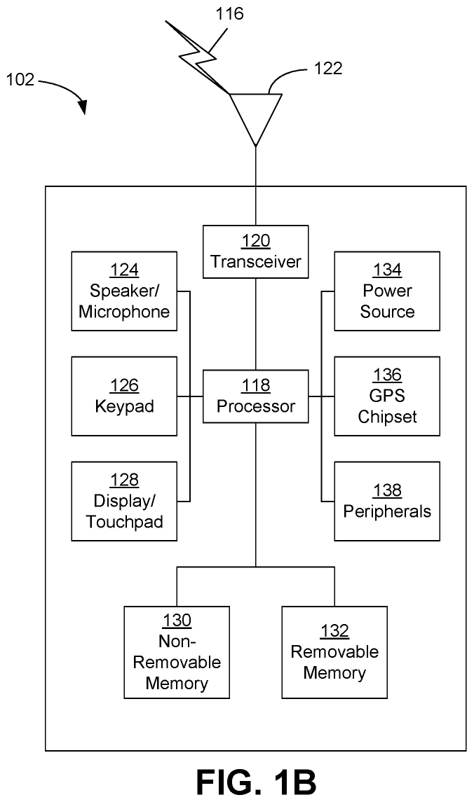

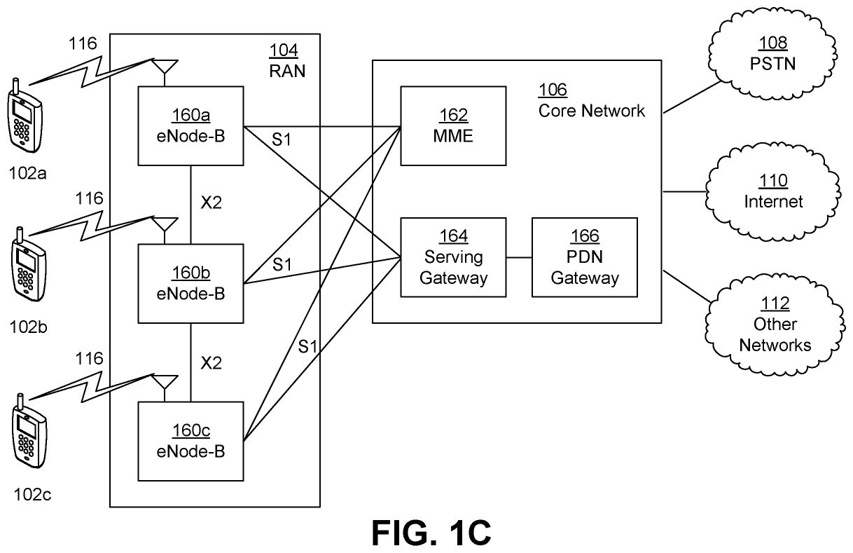

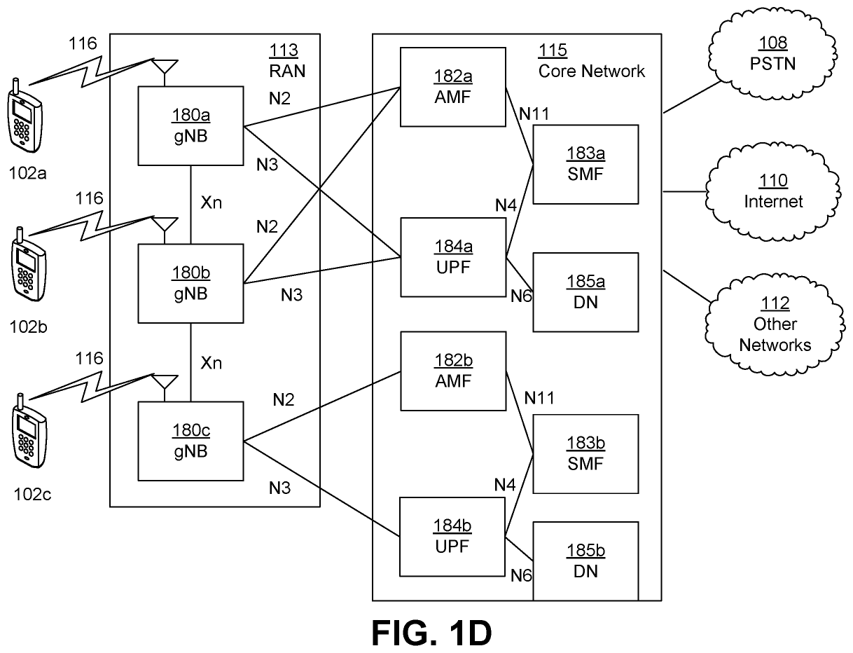

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUS 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUS 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUS 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In a communications system, such as a communication network, an example device, such as an example wireless transmit/receive unit (WTRU), may apply one or more measurement parameters for measuring layer 1 (L1) quality of a cell based on downlink (DL) synchronization status and/or uplink (UL) synchronization status to the cell. For example, the one or more measurement parameters may be or may include filtering coefficients, time to trigger (TTT), and/or the like. Such WTRU may receive one or more of a first set of measurement parameters (e.g., filtering coefficients, TTT, and/or the like) associated with one or more cells to which the WTRU is neither UL nor DL synchronized; a second set of measurement parameters (e.g., filtering coefficients, TTT, and/or the like) associated with one or more cells to which the WTRU is DL synchronized but not UL synchronized; or a third set of measurement parameters (e.g., filtering coefficients, TTT, and/or the like) to be applied to one or more cells to which the WTRU is UL synchronized and DL synchronized.

In examples, based on one or more of the sets of measurement parameters, a WTRU may determine, for a neighbor cell (e.g., a specific neighbor cell) which is an L1/L2 mobility target, whether to maintain DL synchronization to a cell. For example, the WTRU may determine whether to maintain the DL synchronization to the cell based on the L3 reference signal received power (RSRP) of the cell and/or a number of supported synchronization cells.

In examples, based on one or more of the sets of measurement parameters, a WTRU may determine whether the WTRU is UL synchronized to a cell based on whether the cell has the same UL timing as the serving cell. Based on whether the cell is DL/UL synchronized, the WTRU may apply the associated measurement parameters if measuring the cell. If measurement of the cell triggers generation of a measurement report, the WTRU may transmit the measurement report to a network, such as a base station.

In some examples, a WTRU may apply one or more measurement parameters (e.g., filtering coefficients, TTT, and/or the like) based on an indication of priority of data available for transmission in buffers of the WTRU. In examples, a WTRU may receive a first set of measurement parameters (e.g., filtering coefficients, TTT, and/or the like) to be applied to one or more neighbor cells if high priority data is available for transmission. In examples, a WTRU may receive a second set of measurement parameters (e.g., filtering coefficients, TTT, and/or the like) to be applied to the one or more neighbor cells if high priority data is not available for transmission. The WTRU may receive a priority threshold indication. For example, the priority threshold indication may indicate whether data is high priority or not. If high priority data is available in buffers of the WTRU, the WTRU may apply the first set of measurement parameters for measuring L1/L2 candidates. If no high priority data is available in the buffers of the WTRU, the WTRU may apply the second set of measurement parameters for measuring L1/L2 candidates. If measurement of the cell triggers generation of a measurement report, the WTRU may transmit the measurement report to a network, such as a base station.

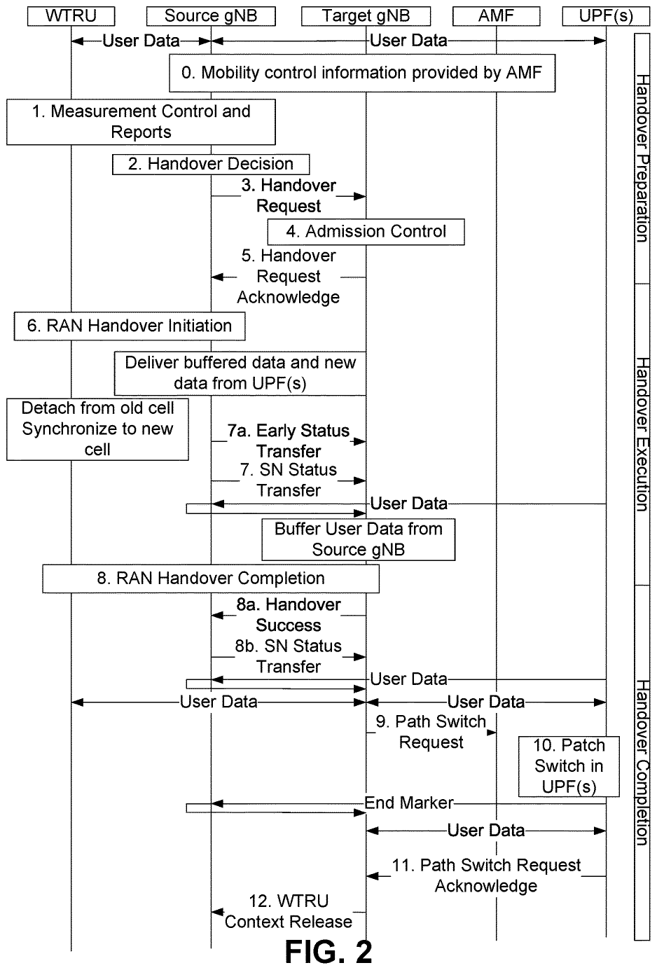

With reference to FIG. 2, an example handover procedure in new radio (NR) is provided. As illustrated in FIG. 2, a WTRU context within a source base station (e.g., a source gNB) may include information regarding roaming and/or access restrictions that may be provided at connection establishment and/or at a timing advance (TA) update. This information may be provided by the access and mobility management function (AMF).

With continued reference to FIG. 2, the source gNB may configure one or more WTRU measurement procedures and the WTRU may report according to the measurement configuration. The source gNB may decide to handover the WTRU. For example, the source gNB may decide to handover the WTRU based on the received measurements. The source gNB may send a handover request message to a target gNB. For example, the source gNB may send a handover request message to the target gNB passing a transparent radio resource control (RRC) container with information to prepare the handover at the target side. Such information may include at least one or more of the following: a target cell ID, KgNB*, a cell radio network temporary identifier (C-RNTI) of the WTRU in the source gNB, a resource management entity (RRM)-configuration including WTRU inactive time, a basic AS-configuration including antenna information and downlink (DL) carrier frequency, a current QoS flow to data radio bearer (DRB) mapping rules applied to the WTRU, a system information block 1 (SIB1) from a source gNB, one or more WTRU capabilities for different radio access technologies (RATs), protocol data unit (PDU) session related information, and/or WTRU-reported measurement information in some examples further including beam-related information (e.g., if available).

With continued reference to FIG. 2, an admission control procedure may be performed by the target gNB. If the WTRU can be admitted, the target gNB may prepare a handover with L1/L2 and send a HANDOVER REQUEST ACKNOWLEDGE indication to the source gNB. The indication may include a transparent container to be sent to the WTRU as an RRC message to perform the handover.

With continued reference to FIG. 2, the source gNB may trigger the WTRU handover by sending an RRCReconfiguration message to the WTRU. The RRC message may include information associated with accessing the target cell: at least one or more of the target cell ID, the new C-RNTI, the target gNB and/or security algorithm identifiers for the selected security algorithms. The RRC message may include information associated with a set of dedicated random access channel (RACH) resources, an indication of association between RACH resources and synchronization signal blocks (SSB(s)), an indication of association between RACH resources and WTRU-specific CSI-RS configuration(s), an indication of common RACH resources, system information of the target cell, etc.

With continued reference to FIG. 2, the source gNB may send an SN STATUS TRANSFER message to the target gNB. The target gNB may convey uplink packet data convergence protocol (PDCP) sequence number (SN) receiver status and/or downlink PDCP SN transmitter status of DRBs for which PDCP status preservation applies (e.g., for radio link control (RLC) acknowledged mode (AM)). The WTRU may synchronize to the target cell and indicate completion of the handover procedure by sending an RRCReconfigurationComplete message to the target gNB.

With continued reference to FIG. 2, the target gNB may send a PATH SWITCH REQUEST indication to AMF to trigger 5G core network (5GC) to switch the DL data path toward the target gNB and/or to establish a next generation control plane (an NG-C) interface instance with the target gNB. 5GC may switch the DL data path towards the target gNB. The user plane function (UPF) may send one or more end marker packets on the previous path to the source gNB per PDU session and/or tunnel and may release one or more user plane (U-plane) resources and/or transport network layer (TNL) resources towards the source gNB.

With continued reference to FIG. 2, the AMF may confirm the PATH SWITCH REQUEST indication using the PATH SWITCH REQUEST ACKNOWLEDGE message. In response to the PATH SWITCH REQUEST ACKNOWLEDGE message from the AMF, the target gNB may send a WTRU CONTEXT RELEASE message to inform the source gNB about the success of the handover. The source gNB may release radio and/or control plane (C-plane) related resources associated with the WTRU context. A data forwarding (e.g., an ongoing data forwarding) may continue.

In the above example handover procedure illustrated in FIG. 2, the WTRU may be provided with a set of one or more measurement parameters associated with performing L3 measurement of neighbor/serving cells. The measurement parameters may include filtering coefficients, TTT, etc. The WTRU may apply the set of one or more parameters to one or more of the serving/neighbor cells if L3 measurements are performed.

Example handover procedures for conditional handover (CHO) and conditional PSCell addition/change (CPA/CPC) may be discussed. In CHO, an example WTRU may be configured (via, e.g., an RRC reconfiguration message) with a handover target (e.g., a target cell configuration) and/or an associated condition in terms of a cell measurement event (e.g., event A3/A5 and corresponding cells). Such WTRU, following configuration by reception of a CHO command, may initiate monitoring of the associated condition. In response to detecting satisfaction of the condition, the WTRU may trigger a handover (e.g., reconfiguration) to the associated cell with the given configuration. For CPC and CPA, a WTRU may trigger a PSCell change or PSCell addition associated with a stored PSCell configuration. For example, for CPC and CPA, a WTRU may trigger a PSCell change or PSCell addition associated with a stored PSCell configuration upon detecting satisfaction of an associated condition defined by a measurement event.

L1/L2 based mobility may be described herein. In an example L1/L2 mobility scenario, a serving cell may remain unchanged (e.g., without possibility of changing the serving cell using L1/2 based mobility). For example, in frequency range 2 (FR2) deployments, carrier aggregation (CA) may be used to exploit available bandwidth, e.g., to aggregate multiple CCs in a band. Such CCs may be transmitted with an analog beam pair (e.g., a common analog beam pair, such as a gNB beam and a WTRU beam). In examples, a WTRU may be configured with transmission configuration indicator (TCI) states (e.g., 64 states) for reception of a physical downlink control channel (PDCCH) transmission and a physical downlink shared channel (PDSCH). A TCI state may include a reference signal (RS) or SSB that the WTRU refers to for setting its beam. The SSB may be associated with a non-serving PCI. MAC signaling (e.g., TCI state indication for UE-specific PDCCH MAC CE) may be utilized to activate the TCI state for a CORESET/PDCCH. Reception of a PDCCH transmission from a non-serving cell may be supported by a MAC CE indicating a TCI state associated with non-serving physical layer cell ID (PCI). MAC signaling (e.g., TCI states activation/deactivation for WTRU-specific PDSCH) may be utilized to activate a subset of TCI states (e.g., up to 8 TCI states) for PDSCH reception. Downlink control information (DCI) may be utilized to indicate which of the subset of TCI states (e.g., the 8 TCI states) are activated or deactivated. Some examples may support a unified TCI state with a different updating mechanism (DCI-based), but without multi-transmission and reception point (TRP). Some examples may support unified TCI state with multi-TRP.

In L1/L2 examples, one or more mechanisms may be provided for reducing handover latency (e.g., improving handover latency). In an example L3 handover or conditional handover (CHO), a WTRU may indicate a measurement report using an RRC signaling. In response to the measurement report, a network, such as a base station, may provide a measurement configuration and/or a conditional handover configuration. In case of handover, the network may provide a configuration about a target cell after the WTRU reports, e.g., using an RRC signaling, that the cell meets a configured radio quality criterion. A network may provide (e.g., provide in advance) a WTRU, target cell configuration and/or measurement criteria associated with the WTRU triggering CHO configuration. The target cell configuration and/or measurement criteria may be provided to reduce handover failure rate due to the delay in sending a measurement report and receiving an RRC reconfiguration. The handover and CHO L3 mobility mechanisms may result in delay due to sending of measurement reports and receiving of target configurations (e.g., in case of L3 handover, such as a conventional L3 handover and/or a non-conventional L3 handover).

L1/L2 mobility may allow an application (e.g., a fast application) of configurations for candidate cells, for example, by dynamically switching between SCells and by switching of a PCell (e.g., by switching the roles between SCell and PCell) without performing RRC signaling.

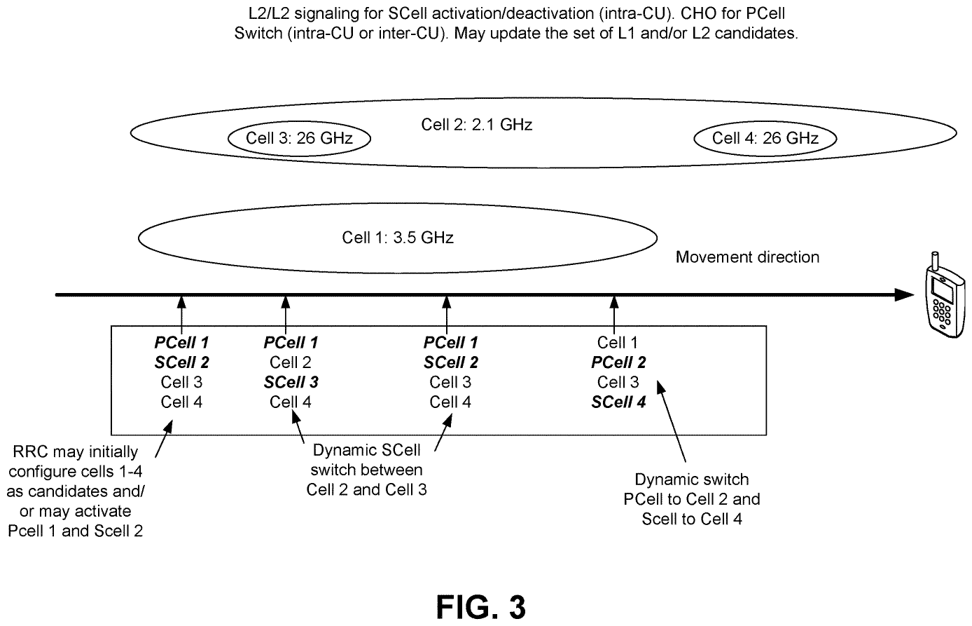

With reference to FIG. 3, FIG. 3 illustrates an example L1/L2 inter-cell mobility operation. As illustrated in FIG. 3, a candidate cell group may be configured using a higher layer signaling (e.g., an RRC signaling) and the dynamic switching of a PCell and an SCell may be achieved by using L1/L2 signaling. As illustrated in FIG. 3, the RRC may trigger (e.g., initially trigger) configuring cells 1-4 as candidates and activating Cell 1 as PCell 1 and Cell 2 as SCell 2. SCell configuration may dynamically switch, e.g., between Cell 2 and Cell 3. PCell configuration may dynamically switch, e.g., between Cell 1 and Cell 2. In the illustrated example, a dynamic PCell switch may be associated with a dynamic SCell switch, e.g., dynamically switching PCell 1 to PCell 2 and dynamically switching SCell to SCell 4.

One or more latency components associated with L1/L2 mobility may be described herein. L1/L2 mobility may be utilized to achieve faster mobility, for example, by reducing one or more latency components associated with mobility. The latency components may include reconfiguration delay, DL synchronization delay, UL synchronization delay, and/or measurement delay.

RRC reconfigurations, for example including those associated with reception of a handover command, may incur some latency at an example WTRU. For example, the WTRU may have to at least decode an RRC message. The WTRU may need to apply parameters and/or configurations associated with the RRC message. Applying the parameters and/or configurations may incur (e.g., need) some interruption. In L1/L2 mobility examples, such configuration may be provided to the WTRU in advance of mobility and delay associated with decoding of the RRC message may be avoided. Further, in some L1/L2 mobility examples, mobility target cell configuration may be similar to an example current serving cell configuration. In an example, intra distributed unit (intra-DU) mobility may include changing parameters within an example SpCellConfig. In an example, inter distributed unit (inter-DU) mobility may include changing parameters within an example CellGroupConfig.

An example WTRU may acquire DL timing associated with a target cell, for example, if the WTRU detects a mobility trigger. The DL timing acquisition may include acquisition of the SSB/beam timing associated with the target cell so that the WTRU may decode a PDCCH/PDSCH associated with the target cell.

An example WTRU may receive a mobility trigger. The WTRU, based on the mobility trigger, may acquire UL timing associated with a target cell to transmit a mobility completion message (e.g., a complete message in L3 handover). The WTRU may perform a RACH procedure to send the mobility completion message. In examples, if the target cell is UL synchronized and the WTRU has a UL resource available for transmission on the target cell, the WTRU may skip performing a RACH procedure.

In examples, L3 measurements may require filtering and application of a TTT before generating a measurement report. In examples, L1 measurements may be utilized and L1 measurements may be sent using less filtering or no filtering. Using L1 measurements may allow the network to determine a better cell faster than using L3 measurements. In examples where a target cell is in good condition temporarily or sporadically, application of L1 measurements without filtering may result in ping ponging (e.g., the WTRU may perform handover to a target cell, subsequently returning to the source cell following degradation of target cell condition).

L1 measurement(s), e.g., instead of L3 measurement(s), may be utilized for mobility by recognizing alternative cell(s)/beam(s). For example, a WTRU may use the L1 measurements to move to an alternative cell and/or an alternate beam, for example, to achieve higher throughput.

Radio link failure (RLF), due to the serving cell quality degrading (e.g., degrading quickly), may be avoided if an HO command is received while the serving cell is of acceptable quality. However, certain handovers may result in ping-ponging. For example, ping-ponging may occur if the target cell is acceptable for a time interval (e.g., a short time interval) while a subsequent HO is performed back to the original source cell. Ping-pong may result in interruption in some cases. For example, if inter-DU mobility is performed, MAC reset may be performed. MAC reset may cause loss of data, for example, stored in the MAC buffers. The loss of data (e.g., the loss of data stored in the MAC buffers) may result in retransmission of data. In certain types of mobility (e.g., intra-DU), MAC reset may not be performed with less averaging.

In some examples, a target cell may be acceptable. For example, a target cell may be acceptable for a short period of time (e.g., only for a short period of time). If a target cell is acceptable only for a short period of time, a subsequent handover to the source cell may be required. Such ping-ponging may result in service interruption in some examples. For example, if inter-DU mobility is performed, MAC reset may cause loss of data from the MAC buffers and may need to perform retransmission of the lost data. In other examples not requiring MAC reset (e.g., intra-DU), mobility may benefit from measurements involving less averaging.

L1 measurements without ping-ponging may be configured and/or used.

In examples, measurement parameters and/or measurement configuration may refer to one or more coefficients or sets of coefficients for filtering of measurements (e.g., L1 measurements, L3 measurements, etc.). A set of coefficients may be used in filtering. The set of coefficients may include the actual value of filtering coefficients and/or a bias, an offset, a factor, or similar for use in choosing a set of filter coefficients over another set of filter coefficients. For example, the actual value of filtering coefficients and/or a bias, an offset, a factor, and/or like may be used to calculate a set of filter coefficients over another set of filter coefficients.

In examples, measurement parameters and/or measurement configuration may refer to one or more specific beams to average and/or consider when deriving a cell measurement. Such measurement parameters may include a number of beams to average (e.g., nrofSS-Blocks ToAverage as configured in an example of RRC signaling). Such parameters may include a threshold or other rule to use in determining whether a beam is considered (e.g., abs ThreshSS-BlocksConsolidation).

In examples, measurement parameters and/or measurement configuration may refer to one or more time to trigger (TTT) parameters associated with a duration during which one or more event conditions associated with a measurement reporting or a CHO configuration remain valid. Such measurement parameters may include a specific value of TTT associated with one or more configured measurement events and/or may include a bias, an offset, a factor, or similar applicable to a configured (e.g., a baseline) value of TTT.

In examples, measurement parameters and/or measurement configuration may refer to one or more offsets associated with one or more Ax-type events. For example, such measurement parameters may include a first offset to be applied to measured values of a cell associated with an event and/or a second offset to be applied to measured values of a cell associated with another event. In examples, application of such offsets may include determining whether to apply a bias to a baseline offset.

In examples, measurement parameters and/or measurement configuration may refer to one or sample rates (e.g., percentages) of measurements (or measurement reports) associated with transmission to the network. In some examples, a WTRU may be configured to send a subset of measurements to a network, such as a base station. For example, a WTRU may be configured to send one measurement out of every X measurements to be reported, where X may depend on factors described herein.

In examples, measurement parameters and/or measurement configuration may refer to one or more periodicities associated with one or more reference signals that are used when determining a cell measurement.

In examples, measurement parameters and/or measurement configuration may refer to one or more averaging periods over which to perform measurements of reference signals associated with a cell measurement.

In examples, measurement parameters and/or measurement configuration may refer to one or more measurement types. For example, such parameters may include a set of L1 filtering coefficients associated with measurements taken at L1 and/or a set of L3 filtering coefficients associated with measurements taken at L3. In examples, a WTRU may determine whether to perform, as part of measurements, L1 measurements, and/or L3 measurements. In examples, a WTRU may determine whether to use a first reference signal or a second reference signal to perform measurements.

In examples, measurement parameters and/or measurement configuration may refer to a specific reference signal, CSI measurement resource, SSB measurement resource, etc., that may be indicated to the WTRU (e.g., as part of the measurement configuration).

In examples, measurement parameters and/or measurement configuration may refer to reporting criteria, such as whether to perform or not to perform periodic or event-triggered reporting, periodicity of reporting, or an event or event configuration (e.g., A3 vs A5, etc.) to be applied when measuring and/or reporting one or more target cells.

It will be appreciated that in various examples, measurement parameters may refer to any one or more of the meanings above, and/or to other meanings not listed. Further, a WTRU may be configured with one or more measurement parameter sets. A measurement parameter set described herein may be associated with one or more cells.

In an example measurement configuration, for a given measurement object (e.g., frequency to be measured), a WTRU may be configured with a set of measurement parameters (e.g., a single set of measurement parameters). As described herein measurement parameters may be or may include filtering coefficients, TTT, and/or the like. Such measurement parameters may be applied to a serving cell and a candidate cell (e.g., each candidate cells) for L3 measurement.

In various examples, a set of measurement parameters may be referred to as a measurement configuration.

In examples, a WTRU may be configured with measurements (e.g., L1 and/or L3). Measurement parameters to be applied may vary among one or more cells to be measured. For example, a WTRU may apply a first set of parameters if a first neighboring cell is measured and may apply a second set of parameters if a second neighboring cell is measured. Based on application of the first set of parameters or the second set of parameters, the WTRU may transmit a measurement report to a network, such as a base station. In some examples, the WTRU may transmit a measurement report to the network where such measurement satisfies one or more configured criteria.

In various embodiments, a WTRU may determine the measurement parameters to apply based on any or a combination of the following factors or mechanisms: cell specific configuration; configuration of a target cell (e.g., possible with respect to a servicing cell configuration); area/cell group specific configuration; downlink synchronization status; uplink synchronization status; whether cell being measured is an SCell; in a message from a network, such as a MAC CE and/or DCI; whether a target cell sic configured with a rest of a protocol layer (e.g., MAC/RLC reset); whether a target cell is associated with RACH-based or RACH-less procedure; and/or based on a result(s) of measurement (e.g., possibly different measurement).

A WTRU may determine the measurement parameters to apply based on, for example, cell-specific configuration. A WTRU may receive a configuration of an L1/L2 mobility candidate cell. Such configuration may include measurement parameters (e.g., filtering coefficients, TTT, etc.) to be used if measurements of the candidate cell are performed. For example, a WTRU may receive a cell-specific configuration from the serving cell for a neighbor cell (e.g., a L1/L2 mobility candidate). In examples, as long as the WTRU remains on the serving cell, the WTRU may perform neighbor cell measurements for the neighboring cell using the measurement parameters configured for the neighbor cell.

A WTRU may determine the measurement parameters to apply based on configuration of a target cell, for example, that is associated with the serving cell configuration. In examples, a WTRU may determine whether to apply a first set of measurement parameters or a second set of measurement parameters for a target cell based on properties associated with the target cell configuration (in some further examples, comparing those measurements with measurements of a serving cell).

For example, a WTRU may determine whether a serving cell and a target cell belong to the same distributed unit (DU) or to different DUs explicitly (for example using configured DU IDs or cell/cell group configuration IDs) or implicitly.

In examples, a WTRU may be configured by a serving cell with two measurement configurations. The WTRU may determine which measurement configuration to apply when measuring a target neighboring cell based on the presence and/or absence of an IE in the target cell configuration. For example, if the target cell configuration is provided using an SpCellConfig IE, the WTRU may apply the first measurement configuration when measuring the target cell. If the target cell configuration is provided using a CellGroupConfig IE, the WTRU may apply the second measurement configuration when measuring the target cell.

In examples, multiple subsequent reconfigurations may be performed without receiving a full cell configuration. If multiple subsequent reconfigurations are performed without receiving a full cell configuration, a WTRU may configured with two measurement configurations and may determine which measurement configuration to apply based on a difference in target cell configuration compared to source cell configuration. For example, if the target cell configuration includes the same RLC/MAC parameters as the source cell configuration or does not otherwise require the WTRU to reconfigure these parameters, the WTRU may use the first measurement configuration; otherwise, the WTRU may use the second measurement configuration.

In examples, a WTRU may determine whether to use a first measurement configuration or a second measurement configuration based on a cell ID of a target cell (e.g., PCI) as compared a cell ID of a source cell. In examples, a relationship between the cell IDs of the source and target cells may exist. For example, the WTRU may determine which measurement configuration to apply based on the target and source cell IDs being within a specific range. For another example, the WTRU may determine which measurement configuration to apply based on whether the target and source cell IDs are a modulo of one another. In more examples, the WTRU may determine which measurement configuration to apply based on other cell ID relationships that may exist. The WTRU may also be configured with a set of cells for which the WTRU may use a first configuration and another set of cells for which the WTRU may use the second configuration.

A WTRU may determine the measurement parameters to apply based on, for example, area-specific configuration and/or cell group-specific configuration. In examples, a WTRU may be configured with a group of cells and/or an area of cells. The configured group of cells and/or the configured area of cells may be similar to a RAN area configuration. The WTRU may determine an applicable measurement configuration based on the group of cells and/or the area of cells. For example, the WTRU may determine an applicable measurement configuration from among two or more configured sets of measurement parameters based on the group of cells and/or the area of cells. In examples, for a target cell belonging to a group of cells that is different than a group of cells to which a serving cell belongs, the WTRU may use a first configuration. In examples, for a cell that is within the same group of cells to which the serving cell belongs, the WTRU may use a second configuration.

In examples, cell-specific configuration for one or more parameters (e.g., certain parameters) of a candidate cell may be associated with (e.g., explicitly associated) with a corresponding serving cell (e.g., PCell). For a candidate cell, a WTRU may be provided with a configuration. In examples, the configuration may be and/or may include {{TTT1, filtering cofficients1}, PCell=Cell1 or Cell 2}, {{TTT2, filtering cofficients2}, PCell=Cell3 or Cell 4}, etc. Such example configuration may indicate to the WTRU to apply a first set of parameters if the PCell is set to Cell1 or Cell2 and apply a second set of parameters, if the PCell is set to Cell3 or Cell4, etc. In examples, the configuration may be and/or may include the following: {{TTT1, filtering cofficients1}, if the WTRU is configured with Cell1 or Cell 2 as a serving cell}, {{TTT2, filtering cofficients2}, if the WTRU has Cell2 or Cell 2 as a serving cell}, etc. Such example configuration may indicate to the WTRU to apply a first set of parameters if the WTRU is configured with Cell1 or Cell2 as a serving cell (e.g., PCell, SCell, PSCell, etc.) and apply a second set of parameters if the PCell set to Cell3 or Cell4 are configured as serving cells, etc. In such examples Cell1/Cell2/Cell3/Cell4 may be identified by one or more cell identifiers, such as serving cell indexes, PCIs, etc.

In examples, one or more other groupings may be configured based on one or more characteristics of the cells. For example, one or more other groupings may be configured based on one or more characteristics of the cells instead of explicit IDs, discussed herein. As described herein, a rule may be used. For example, as described herein, one or more parameters may be applied for the measurements of a neighbor cell if the WTRU is configured with PCell and/or SCell with certain frequencies or is within a certain frequency range, bandwidth range, capabilities, numerology, etc.

A WTRU may determine the measurement parameters to apply based on downlink synchronization status. In examples, a WTRU may determine whether to use a first measurement configuration or a second measurement configuration based on downlink synchronization status of a target cell at the time of the measurements. The determination of downlink synchronization status of the target cell at the time of the measurement may be whether the WTRU has acquired the timing of an SSB/beam, whether the WTRU monitors PDCCH on the target cell, and/or the like. In examples, the WTRU may use a first configuration if the WTRU is downlink synchronized to an L1/L2 mobility candidate. In examples, the WTRU may use a second configuration if the WTRU is not downlink synchronized to the L1/L2 mobility candidate.

In examples, a WTRU may autonomously determine one or more target cells on which to maintain downlink synchronization. For example, the WTRU may rank one or more configured L1/L2 mobility targets by cell quality, beam quality, number of beams, and/or etc. The WTRU may determine best N cells on which to maintain downlink synchronization. In examples, a value of N may be configured. In examples a value of N may be based on (e.g., depend on) capability of the WTRU. For example, the WTRU may use a first set of measurement parameters for one or more target cells on which the WTRU maintains downlink synchronization and may use a second set of measurement parameters to measure one or more target cells on which the WTRU does not maintain downlink synchronization. In examples, the WTRU may use one or more configured measurement parameters and/or default measurement parameters to perform measurements on one or more potential target cells, e.g., in order to rank the one or more potential target cells for determining one or more cells on which to maintain synchronization.

In examples, a WTRU may receive a set of target cells on which to maintain synchronization. In examples, the WTRU may receive an indication to add and/or remove a cell from the set of target cells. The WTRU may receive the indication via MAC CE, via DCI, and/or the like. In examples, based on the set of target cells, the WTRU may use a first measurement configuration to perform measurements of the target cells on which the WTRU maintains DL synchronization. In examples, based on the set of target cells, the WTRU may use a second measurement configuration to perform measurements of the target cells on which the WTRU does not maintain DL synchronization.

A WTRU may determine the measurement parameters to apply based on uplink synchronization status. In examples, a WTRU may determine whether to use a first measurement configuration or a second measurement configuration for measuring a target cell based on UL synchronization status of the target cell. In examples, for a target cell to which a WTRU is uplink synchronized, the WTRU may measure the target cell with a first measurement configuration. In examples, for a target cell to which the WTRU is not uplink synchronized, the WTRU may measure the target cell with a second measurement configuration. Such example WTRU may determine whether the WTRU is UL synchronized to a target cell based on determining one or more of the following: whether target cell configuration includes an indication, such as an explicit indication, indicating whether the WTRU performs RACH-less mobility to the target cell or not; whether the target cell is configured as part of the same timing advance group as the serving cell; whether the WTRU is provided with RACH resources for the target cell; whether the WTRU maintains UL synchronization to the target cell; and/or the last time that the WTRU received timing information (e.g., timing advance) associated with the target cell from the serving cell, such as the time elapse sine the WTRU received the timing information.

A WTRU may determine one or more measurement parameters to apply based on whether a cell being measured is an SCell. For example, a WTRU may determine whether to use a first measurement configuration or a second measurement configuration for measuring a target cell based on whether the target cell is an SCell at the time of performing the measurements. The WTRU may change from one measurement configuration to another measurement configuration for a target cell (e.g., a potential L1/L2 target cell) after the target cell has become an SCell via an L1/L2 mobility cell switch. In examples, if a WTRU determines that a target cell is an SCell, e.g., at the time of performing the measurement, the WTRU may use a first measurement configuration. In examples, if a WTRU determines that a target cell is not an SCell, e.g., at the time of performing the measurement, the WTRU may use a second measurement configuration.

A WTRU may determine one or more measurement parameters to apply based on a message from a network. The message may be sent from the network using a MAC CE, DCI, and/or the like. A WTRU may receive an indication of one of multiple measurement configurations (e.g., TTT, filtering coefficients, and/or the like as described herein). For example, the WTRU may receive the indication via RRC messaging. The WTRU may, e.g., after receiving the indication, change from using a first measurement configuration to using a second measurement configuration following reception of a L1/L2 message (e.g., MAC CE, or DCI). For example, a WTRU may be configured with multiple measurement configurations in RRC. Measurement configuration (e.g., each measurement configuration) may be with an associated index. The WTRU may receive a message, such as a MAC CE message. The message may be configured to enable a configuration, disable a configuration, or switch from one configuration to another. In examples, the message, such as the MAC CE message, may indicate the index of one of the configurations.

A WTRU may determine one or more measurement parameters to apply based on whether a target cell is configured with a reset of a protocol layer, such as a MAC reset and/or RLC reset. A WTRU may receive a configuration for a candidate target cell. The configuration may include an indication of whether to reset or re-establish a protocol layer during a cell switch. For example, a WTRU may receive a flag, such as a reset MAC flag, a rest RLC flag, and/or the like, indicating whether to reset a specific protocol layer with each target cell configuration upon L1/L2 mobility to the target cell. For example, a WTRU may receive a flag associated with the target cell and/or the source cell. Based on the received flag, the WTRU may apply either a first measurement configuration or a second measurement configuration during measurements of the target cell. In examples, if the WTRU receives a flag indicating to reset a specific protocol layer upon L1/L2 mobility to the target cell, the WTRU may apply a first measurement configuration. In examples, if the WTRU receives a flag indicating to maintain (e.g., not to reset) a specific protocol layer upon L1/L2 mobility to the target cell, the WTRU may apply a second measurement configuration.

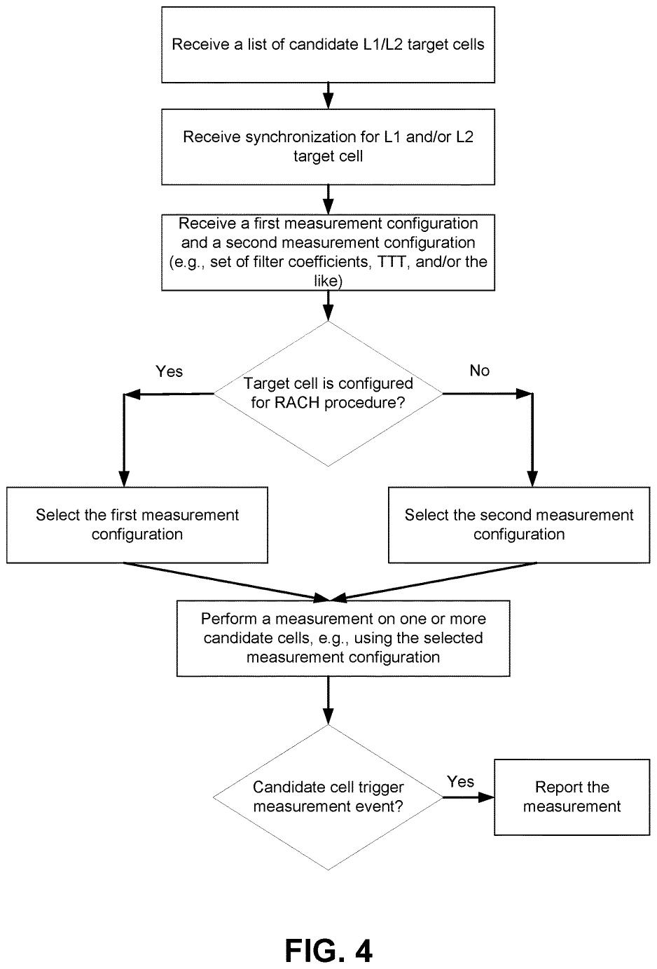

FIG. 4 illustrates an example flow diagram of a WTRU selecting a measurement configuration for a cell and performing a measurement on the cell based on the selected measurement configuration. For example, a WTRU may determine one or more measurement parameters to apply based on whether a cell, such as a target cell, is associated with RACH-based procedure or RACH-less procedure. As described herein, the WTRU may receive candidate cell information. For example, the WTRU may receive a first candidate cell information and a second candidate cell information. The candidate cell information may indicate a candidate cell and/or a synchronization configuration. For example, the first candidate cell information may indicate a first candidate cell and/or a first synchronization configuration and the second candidate cell information may indicate a second candidate cell and/or a second synchronization configuration.

As illustrated in FIG. 4, the WTRU may receive a measurement configuration. For example, the WTRU may receive a first measurement configuration and/or a second measurement configuration. The WTRU may select a measurement configuration, e.g., the first measurement configuration or a second measurement configuration. For example, the WTRU may select a measurement configuration associated with a first candidate cell based on whether the first synchronization configuration indicates that the first candidate cell is associated with a RACH procedure or a RACH-less procedure. In examples, if the first candidate cell uses the RACH procedure and/or is associated with the RACH procedure, the WTRU may select the first measurement configuration. The determination that the first candidate cell uses the RACH procedure and/or is associated with the RACH procedure may be based on the first synchronization configuration indicating that the first candidate cell is unsynchronized. In examples, if the first candidate cell uses the RACH-less procedure and/or is associated with the RACH-less procedure, the WTRU may select the second measurement configuration. The determination that the first candidate cell uses the RACH-less procedure and/or is associated with the RACH-less procedure may be based on the first synchronization configuration indicating that the first candidate cell is synchronized.

In examples, the WTRU may select a measurement configuration associated with a second candidate cell based on whether the second synchronization configuration indicates that the second candidate cell is associated with a RACH procedure or a RACH-less procedure. In examples, if the second candidate cell uses the RACH procedure and/or is associated with the RACH procedure, the WTRU may select the first measurement configuration. The determination that the second candidate cell uses the RACH procedure and/or is associated with the RACH procedure may be based on the second synchronization configuration indicating that the second candidate cell is unsynchronized. In examples, if the second candidate cell uses the RACH-less procedure and/or is associated with the RACH-less procedure, the WTRU may select the second measurement configuration. The determination that the second candidate cell uses the RACH-less procedure and/or is associated with the RACH-less procedure may be based on the second synchronization configuration indicating that the second candidate cell is synchronized.

As illustrated in FIG. 4, the WTRU may perform a measurement (e.g., a first measurement) of the first candidate cell based on the selected measurement configuration. The WTRU may transmit a measurement report, such as a first measurement report. For example, the first measurement report may indicate the measurement of the first candidate cell.

In examples, the WTRU may perform a measurement (e.g., a second measurement) of the second candidate cell based on the selected measurement configuration. The WTRU may transmit a measurement report, such as a second measurement report. For example, the second measurement report may indicate the measurement of the second candidate cell.

As described herein and illustrated in FIG. 4, a WTRU may determine whether to perform measurements according to a first configuration or a second configuration, based on whether the WTRU is configured with RACH procedure (e.g., RACH-based procedure) or RACH-less procedure. Whether a WTRU performs RACH-based on RACH-less cell switch procedure may be configured to the WTRU (e.g., configured per source and target cell pair, for examples as described herein). For example, if the WTRU is configured with RACH-based cell switch to a target cell, the WTRU may perform measurements of that target cell according to a first measurement configuration. If the target cell is configured with RACH-less procedure, the WTRU may perform measurements of the target cell according to a second cell configuration.

A WTRU may determine one or more measurement parameters to apply based on the results of a measurement (e.g., a different measurement). For example, a WTRU may determine a measurement configuration associated with a first measurement based on measurement results associated with a second measurement (e.g., both measurements associated with the same target cell or each measurement associated with a different target cell). For example, a WTRU may be configured with configurations (e.g., different configurations) for performing L1 measurements of a target cell. The WTRU may select the configuration to be applied based on the value of another measurement (e.g., an L3 measurement), for example, a measurement of the same or a different cell. For example, the WTRU may use a first measurement configuration if the L3 measurements of a cell (e.g., a target cell or a source cell) exceed a threshold and use a second measurement configuration if the L3 measurements are within the threshold. The second measurement may be of a different type (e.g., L1 RSRP rather than L3 RSRP), a different reference signal, etc. In examples, the second measurement may be of the same type or reference signal and measurement configuration to use for the second measurement may be based on a configuration, such as a default configuration configured in RRC. In examples, the second measurement may correspond to the same cell (e.g., the target cell in question) or a different cell (e.g., the source cell), whereby the target may be a valid L1/L2 mobility target.

In examples, a WTRU may be configured with one or more measurement parameters to use based on previous mobility results. In examples, a WTRU may determine one or more measurement parameters to used based on previous results of mobility and/or on historical data associated with L1/L2 or L3 handover. For example, the WTRU may determine and/or measure one or more of the following: the number of L1/L2 or L3 handovers; the rate at which the WTRU performs L1/L2 or L3 handovers; the time from the last mobility event; whether a cell switch follows an RRC reconfiguration or a subsequent L1/L2 cell switch; whether a cell was a previous target of a cell switch; a measure of the ping-pong rate, such as a measure of the rate at which the WTRU performed a certain number of mobility events or a measure of how often the WTRU has performed mobility away from and back to a certain cell; and/or measurement may be taken over an a configured time span and/or duration.

In examples, a WTRU may select a measurement configuration (e.g., a first measurement configuration or a second measurement configuration) based on the last time that timing information (e.g., timing advance) associated with a candidate cell has been received. For example, the WTRU may select a first measurement configuration based on the time elapsed since the timing information associated with a first candidate cell has been received. In examples, the WTRU may receive the timing information, e.g., using the synchronization configuration. The timing information may be or may include timing advance to be used for a transmission, such as an UL transmission, to a cell (e.g., the first candidate cell). In examples, the WTRU may determine the time elapsed since the timing information has been received. Based on the time elapsed since the timing information has been received, the WTRU may determine the last time that the timing information associated with the first candidate cell has been received. As described herein, the timing information (e.g., the timing advance) may be received using the synchronization configuration (e.g., the first synchronization configuration). For example, based on the first synchronization configuration, the WTRU may determine the time elapsed since the timing information associated with the first candidate cell has been received. For example, the WTRU may determine the last time that timing information associated with the first candidate cell has been received based on the first synchronization configuration. The WTRU may determine whether the time elapsed since the timing information has been received is above a threshold level or below the threshold level. If the WTRU determines that the time elapsed since the timing information has been received is above a threshold level, the WTRU may select the first measurement configuration. If the WTRU determines that the time elapsed since the timing information has been received is below the threshold level, the WTRU may select the second measurement configuration. In examples, the threshold level may be preconfigured. In examples, the threshold level may be received from a base station. Based on the time elapsed since timing information associated with a candidate cell has been received (e.g., the last time that timing information associated with a candidate cell has been received) as described herein, the WTRU may perform a measurement of the first candidate cell based on the selected measurement configuration. The WTRU may transmit a measurement report. The measurement report may indicate the measurement of the first candidate cell.

In examples, a WTRU may select a second measurement configuration based on the last time that timing information (e.g., timing advance) associated with a candidate cell has been received. For example, the WTRU may select a second measurement configuration based on the time elapsed since the timing information associated with a second candidate cell has been received. In examples, the WTRU may receive the timing information, e.g., using the synchronization configuration. The timing information may be or may include timing advance to be used for a transmission, such as an UL transmission, to a cell (e.g., the second candidate cell). In examples, the WTRU may determine the time elapsed since the timing information has been received. Based on the time elapsed since the timing information has been received, the WTRU may determine the last time that the timing information associated with the second candidate cell has been received. As described herein, the timing information (e.g., the timing advance) may be received using the synchronization configuration (e.g., the second synchronization configuration). For example, based on the second synchronization configuration, the WTRU may determine the time elapsed since the timing information associated with the second candidate cell has been received. For example, the WTRU may determine the last time that timing information associated with the second candidate cell has been received based on the second synchronization configuration. The WTRU may determine whether the time elapsed since the timing information has been received is above a threshold level or below the threshold level. If the WTRU determines that the time elapsed since the timing information has been received is above a threshold level, the WTRU may select the first measurement configuration. If the WTRU determines that the time elapsed since the timing information has been received is below the threshold level, the WTRU may select the second measurement configuration. In examples, the threshold level may be preconfigured. In examples, the threshold level may be received from a base station. Based on the time elapsed since timing information associated with a candidate cell has been received (e.g., the last time that timing information associated with a candidate cell has been received) as described herein, the WTRU may perform a measurement of the first candidate cell based on the selected measurement configuration. The WTRU may transmit a measurement report. The measurement report may indicate the measurement of the second candidate cell.

In examples associated with determining whether a cell switch follows an RRC reconfiguration or a subsequent L1/L2 cell switch, one or more of the following may apply. For example, a WTRU may use a first measurement configuration for measurement of one or more target cells following an RRC reconfiguration and/or following L3 mobility. The WTRU may use a second measurement configuration for measurement of one or more target cells following one or more L1/L2 mobility/cell switches after the last reconfiguration/L3 handover. The WTRU may apply a configuration (e.g., a different measurement configuration) based on a number of L1/L2 cell switches (e.g., subsequent L1/L2 cell switches) that occurred since the last reconfiguration.

In examples associated with determining whether a cell was a previous target of a cell switch (e.g., which may be from the last time that a reconfiguration was performed and/or which may be associated with that cell), one or more of the following may apply. For example, a WTRU may use a first measurement configuration for measurement of a target cell if the target cell was not previously a PCell or an SCell of the WTRU, e.g., since the last L3 reconfiguration or L3 handover. The WTRU may use a second measurement configuration for measurement of a target cell if the target cell was previously a PCell or an SCell, e.g., at least one time during the period of time since the last L3 reconfiguration/HO. The WTRU may use a configuration (e.g., different measurement configuration) based on the number of subsequent L1/L2 cell switches that was performed to the target cells since the last L3 reconfiguration/handover.

By way of illustration, the WTRU may change from using a first set of measurement parameters to using a second set of measurement parameters following an event associated with the rate at which the WTRU performs mobility to/from a cell within a period of time (e.g., associated with the ping-pong rate). The WTRU may maintain the second set of measurement parameters if the measured ping pong rate exceeds a configured threshold.

By way of illustration, the WTRU may be configured to change from using a first set of measurement parameters to using a second set of measurement parameters following an L1/L2 handover or an L3 handover. The WTRU may be configured to use the second set of measurement parameters until expiry of a timer (e.g., for a configured amount of time) following the last mobility event.

By way of illustration, the WTRU may be configured with a baseline measurement configuration and to scale the parameters of the configuration depending on one or more of the mobility related events described herein. For example, the WTRU may scale up the TTT associated with a measurement event (e.g., for a particular target cell) by a scaling factor if a measurement of the ping-pong rate on a cell exceeds a configured threshold. In examples, such rate may be measured within a configured time span.

In examples, a WTRU may be configured with one or more measurement parameters based on UL and/or DL data. For example, a WTRU may determine measurement parameters to be used to measure one or more L1/L2 mobility targets based on properties of data to be transmitted at the WTRU, such as configured bearers, or available for transmission at the WTRU, such as active bearers, UL buffer status, and/or the like. In examples, as described herein, the WTRU may select a measurement configuration (e.g., a first measurement configuration and/or a second measurement configuration) based on a type of resource available for transmission. For example, the WTRU may determine whether a resource available for transmission is associated with an ultra-reliable low latency (URLLC)-type traffic (e.g., associated with a medium access control (MAC) reset) or an enhanced massive mobile broadband (eMBB)-type traffic (e.g., not associated with a MAC reset). Based on a determination that the resource available for transmission is associated with the URLLC-type traffic (e.g., associated with a MAC reset), the WTRU may select the first measurement configuration. Based on a determination that the resource available for transmission is associated with the eMBB-type traffic (e.g., not associated with a MAC reset), the WTRU may select the second measurement configuration.

In examples, the WTRU may determine whether a resource available for transmission is associated with a MAC reset. If the resource available for transmission is associated with a MAC reset, the WTRU may select the first measurement configuration. If the resource available for transmission is not associated with the MAC reset, the WTRU may select the second measurement configuration.

Based on the type of resource available for transmission as described herein, the WTRU may perform a measurement of the first candidate cell and/or the second candidate cell based on the selected measurement configuration. The WTRU may transmit a measurement report. For example, the measurement report may indicate the measurement of the first candidate cell and/or the measurement of the second candidate cell.

In examples, a WTRU associated with eMBB-like traffic, e.g., where latency of a particular packet is not critical but achieving large overall throughput is important, an aggressive L1/L2 mobility may be advantageous. In examples, more frequent ping-pongs may be acceptable for eMBB and/or eMBB-like traffic. In examples, a WTRU associated with URLLC-type traffic, L1/L2 mobility may prioritize avoidance of ping-pongs (e.g., for cases where mobility may lead to interruption such as a MAC reset).

In examples, a WTRU may determine one or more measurement parameters (e.g., one or more measurement configurations) to be used for one or more L1/L2 mobility targets based on buffered UL data and/or one or more conditions associated with the buffered UL data. Such determination may further be based on whether the buffered UL data belongs to one or more bearers and/or LCHs. In examples, if an amount of data buffered at the WTRU (e.g., data associated with a configured or predetermined LCH) exceeds a threshold, the WTRU may use a first set of measurement parameters. In examples, if an amount of data buffered at the WTRU (e.g., data associated with a configured or predetermined LCH) is below a threshold, the WTRU may use a second set of measurement parameters. By way of illustration, if the WTRU has data available for transmission (e.g., buffered) associated with a configured or predetermined LCH or for a period of time after the WTRU had at least some data available for transmission associated with a configured or predetermined LCH, the WTRU may use a first set of measurement parameters. In examples, if the WTRU does not have data available for transmission (e.g., buffered) associated with a configured or predetermined LCH or for a period of time after the WTRU had no data available for transmission associated with a configured or predetermined LCH, the WTRU, may use a second set of measurement parameters. In examples, the WTRU may determine the time since the WTRU last had the data available for transmission. If the WTRU determines that the time since the WTRU last had the data available for transmission exceeds a threshold level, such as a threshold period of time, the WTRU may select/use a first set of measurement parameters (e.g., a first measurement configuration). If the WTRU determines that the time since the WTRU last had the data available for transmission is less than a threshold level, such as a threshold period of time, the WTRU may select and/or use a second set of measurement parameters (e.g., a second measurement configuration).

In examples, as described herein, a WTRU may select a measurement configuration (e.g., a first measurement configuration or a second measurement configuration) based on an amount of UL data buffered at the WTRU. For example, the WTRU may determine whether an amount of UL data buffered at the WTRU exceeds a threshold level. In examples, the threshold level may be preconfigured. In examples, the threshold level may be received from a base station. If the WTRU determines that the amount of UL data buffered at the WTRU exceeds the threshold level, the WTRU may select the first measurement configuration. If the WTRU determines that the amount of UL data buffered at the WTRU is below (e.g., does not exceed) the threshold level, the WTRU may select the second measurement configuration. Based on the amount of UL data buffered at the WTRU as described herein, the WTRU may perform a measurement of the first candidate cell and/or the second candidate cell based on the selected measurement configuration. The WTRU may transmit a measurement report. The measurement report may indicate the measurement of the first candidate cell and/or the second candidate cell.

In examples, a WTRU may determine one or more measurement parameters for one or more mobility targets based on one or more properties associated with DL scheduled data. The one or more properties associated with DL scheduled data may include priority of the DL data. In examples, following the scheduling of high priority data, the WTRU may perform one or more measurements using a first set of measurement parameters. In examples, by not following the scheduling of high priority data, the WTRU may change from using a first set of parameters to using a second set of parameters. The one or more properties associated with DL scheduled data may include an amount of DL data. In examples, if the amount of DL data (e.g., associated with one or more bearers) received over a period of time exceeds a threshold, the WTRU may use a first set of measurement parameters. In examples, if the amount of DL data (e.g., associated with one or more bearers) received over a period of time is below (e.g., does not exceed) a threshold, the WTRU may use a second set of measurement parameters. The one or more properties associated with DL scheduled data may include time elapsed between scheduled data receipts, in some examples further associated with a priority. For example, events associated with the priority or the amount of DL data may further depend on the time between such events. In examples, if the time between reception of high priority data exceeds a threshold, a WTRU may use a configured set of measurement parameters, such as a first set of measurement parameters. In examples, if the time between reception of high priority data is below (e.g., does not exceed) a threshold, a WTRU may use a configured set of measurement parameters (e.g., a different configured set of measurement parameters), such as a second set of measurement parameters.

In examples, a WTRU may use one or more parameters for serving cell measurements corresponding with selected neighbor cell parameters. In examples, during evaluation of measurement events (e.g., L1 or L3 events which may trigger measurement reports or events which may initiate some conditional mobility operations at the WTRU), the WTRU may use a measurement configuration associated of a serving cell as the measurement configuration for a neighbor cell associated to that event.

A WTRU may perform evaluation of measurement events (e.g., L1 or L3 events that may trigger measurement reports or may initiate conditional mobility operations at the WTRU). The WTRU may use a set of parameters for the measurement of the serving cell. The set of parameters used for the measurement of the serving cell may be same set of parameters used for a neighboring cell associated with that event. In an example, a WTRU, while evaluating an A3-like event, may be configured with a set of parameters (e.g., filtering parameters) that may be based on the target of the A3 event. In an example, while evaluating an A3 event, the serving cell measurement may be evaluated using the filtering parameters that are similar to the ones as used for measurement of a cell to which the serving cell is being compared for that event. For example, the same parameters may be used (e.g., filtering coefficients, number of coefficients, etc.) for the target cell of the event as for the serving cell for the same event. The relationship of the target parameters to source parameters to be used may be configured by the network.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor.

Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU) comprising:
a processor configured to:
receive a first candidate cell information and a second candidate cell information, wherein the first candidate cell information indicates a first candidate cell and a first synchronization configuration, and wherein the second candidate cell information indicates a second candidate cell and a second synchronization configuration;
receive a first measurement configuration and a second measurement configuration;
select a measurement configuration associated with the first candidate cell, wherein the selection of the measurement configuration is based on whether the first synchronization configuration indicates that the first candidate cell is associated with a random access channel (RACH) procedure or a RACH-less procedure, and wherein the measurement configuration is the first measurement configuration or the second measurement configuration;
perform a measurement of the first candidate cell based on the selected measurement configuration; and
transmit a measurement report, wherein the measurement report indicates the measurement of the first candidate cell.

2. The WTRU of claim 1, wherein if the first candidate cell is associated with the RACH procedure, the selected measurement configuration is the first measurement configuration, and wherein if the first candidate cell is associated with the RACH-less procedure, the selected measurement configuration is the second measurement configuration.

3. The WTRU of claim 2, wherein:
a determination that the first candidate cell is associated with the RACH procedure is based on the first synchronization configuration indicating that the first candidate cell is unsynchronized; and
a determination that the first candidate cell is associated with the RACH-less procedure is based on the first synchronization configuration indicating that the first candidate cell is synchronized.

4. The WTRU of claim 1, wherein the processor is further configured to:
determine whether a resource available for transmission is associated with a medium access control (MAC) reset;
wherein based on a determination that the resource available for the transmission is associated with the MAC reset, the selected measurement configuration is the first measurement configuration; and
wherein based on a determination that the resource available for the transmission is not associated with the MAC reset, the selected measurement configuration is the second measurement configuration.

5. The WTRU of claim 4, wherein the resource available for the transmission that is associated with the MAC reset is associated with an ultra-reliable low latency (URLLC)-type traffic and the resource available for the transmission that is not associated with the MAC reset is associated with an enhanced massive mobile broadband (eMBB)-type traffic.

6. The WTRU of claim 1, wherein the processor is further configured to:
based on the first synchronization configuration, determine a time elapsed since timing information associated with the first candidate cell has been received;
wherein based on the determination that the time elapsed since the timing information has been received is above a threshold level, the selected measurement configuration is the first measurement configuration; and
wherein based on the determination that the time elapsed since the timing information has been received is below the threshold level, the selected measurement configuration is the second measurement configuration.

7. The WTRU of claim 1, wherein the processor is further configured to:
determine whether uplink (UL) data has been buffered at the WTRU exceeds a threshold level;
wherein based on a determination that the UL data has been buffered at the WTRU exceeds the threshold level, the selected measurement configuration is the first measurement configuration; and
wherein based on a determination that the UL data has been buffered at the WTRU is below the threshold level, the selected measurement configuration is the second measurement configuration.

8. The WTRU of claim 1, wherein the measurement is a first measurement and the measurement report is a first measurement report, and wherein the processor is configured to:
select a measurement configuration associated with the second candidate cell, wherein the selection of the measurement configuration is based on whether the second synchronization configuration indicates that the second candidate cell is associated with a RACH procedure or a RACH-less procedure, and wherein the measurement configuration is the first measurement configuration or the second measurement configuration;
perform a second measurement of the second candidate cell based on the selected measurement configuration; and
transmit a second measurement report, wherein the second measurement report indicates the second measurement of the second candidate cell.

9. A method comprising:
receiving a first candidate cell information and a second candidate cell information, wherein the first candidate cell information indicates a first candidate cell and a first synchronization configuration, and wherein the second candidate cell information indicates a second candidate cell and a second synchronization configuration;
receiving a first measurement configuration and a second measurement configuration;
selecting a measurement configuration associated with the first candidate cell, wherein the selection of the measurement configuration is based on whether the first synchronization configuration indicates that the first candidate cell is associated with a random access channel (RACH) procedure or a RACH-less procedure, and wherein the measurement configuration is the first measurement configuration or the second measurement configuration;
performing a measurement of the first candidate cell based on the selected measurement configuration; and
transmitting a measurement report, wherein the measurement report indicates the measurement of the first candidate cell.

10. The method of claim 9, wherein if the first candidate cell is associated with the RACH procedure, the selected measurement configuration is the first measurement configuration, and wherein if the first candidate cell is associated with the RACH-less procedure, the selected measurement configuration is the second measurement configuration, and wherein
a determination that the first candidate cell is associated with the RACH procedure is based on the first synchronization configuration indicating that the first candidate cell is unsynchronized; and
a determination that the first candidate cell is associated with the RACH-less procedure is based on the first synchronization configuration indicating that the first candidate cell is synchronized.

11. The method of claim 9, wherein the method comprises:
determining whether a resource available for transmission is associated with a medium access control (MAC) reset;
wherein based on a determination that the resource available for the transmission is associated with the MAC reset, the selected measurement configuration is the first measurement configuration; and
wherein based on a determination that the resource available for the transmission is not associated with the MAC reset, the selected measurement configuration is the second measurement configuration.

12. The method of claim 9, wherein the method comprises:
based on the first synchronization configuration, determining a time elapsed since timing information associated with the first candidate cell has been received;
wherein based on the determination that the time elapsed since the timing information has been received is above a threshold level, the selected measurement configuration is the first measurement configuration; and
wherein based on the determination that the time elapsed since the timing information has been received is below the threshold level, the selected measurement configuration is the second measurement configuration.

13. The method of claim 9, wherein the method comprises:
determining whether uplink (UL) data has been buffered exceeds a threshold level;
wherein based on a determination that the UL data has been buffered exceeds the threshold level, the selected measurement configuration is the first measurement configuration; and
wherein based on a determination that the UL data buffered has been buffered is below the threshold level, the selected measurement configuration is the second measurement configuration.

14. The method of claim 9, wherein the measurement is a first measurement and the measurement report is a first measurement report, and wherein the method further comprises:
selecting a measurement configuration associated with the second candidate cell, wherein the selection of the measurement configuration is based on whether the second synchronization configuration indicates that the second candidate cell is associated with a RACH procedure or a RACH-less procedure, and wherein the measurement configuration is the first measurement configuration or the second measurement configuration;
performing a second measurement of the second candidate cell based on the selected measurement configuration; and
transmitting a second measurement report, wherein the second measurement report indicates the second measurement of the second candidate cell.

15. The method of claim 9, wherein the measurement configuration comprises one or more of filtering coefficients or time to trigger (TTT).

16. The method of claim 11, wherein the resource available for the transmission that is associated with the MAC reset is associated with an ultra-reliable low latency (URLLC)-type traffic and the resource available for the transmission that is not associated with the MAC reset is associated with an enhanced massive mobile broadband (eMBB)-type traffic.
